(19) United States
(12) Patent Application Publication
(10) Pub. No.: US 2024/0090520 A1
(43) Pub. Date: Mar. 21, 2024

(54) LOW SUGAR ACIDIFIED PRODUCT

(71) Applicant: VALIO LTD, Helsinki (FI)

(72) Inventors: Soile TYNKKYNEN, Helsinki (FI); Katri HALLAMAA, Helsinki (FI)

(21) Appl. No.: 18/262,237

(22) PCT Filed: Jan. 21, 2022
(86) PCT No.: PCT/FI2022/050040

§ 371 Date: Jul. 20, 2023

(30) Foreign Application Priority Data
Jan. 21, 2021 (FI) 20215074

(51) Int. Cl. A23C 9/123; A23C 9/12; A23C 9/13; A23C 9/142

(52) U.S. Cl. CPC A23C 9/1234; A23C 9/1206; A23C 9/1307; A23C 9/1322; A23C 9/1422; A23C 9/1427

(57) ABSTRACT

A method for producing a low sugar acidified milk product includes providing a milk base having a protein content of about 2.5% to about 8%, a fat content of about 0% to about 10%, a lactose content of about 0.6% to about 2.5% and an ash content of about 0.6% to about 0.9%; adding a citrate preparation to the milk base; optionally homogenizing the milk base; pasteurizing the base milk; fermenting the milk base with a starter culture to provide a low sugar acidified milk product having a pH of about 4.4 to about 4.7. A low sugar acidified milk product includes added citrate preparation in an amount of about 0.1% to about 0.18%, calculated as a pure citrate. A low sugar acidified milk product, wherein the total citrate concentration of the product in the range of about 0.1% to about 0.25%, calculated as pure citrate.

### FIELD OF THE INVENTION

The present invention relates to a low sugar acidified milk product and a process for its preparation.

### BACKGROUND OF THE INVENTION

There is a global trend for healthier eating and for overall well-being of individuals. It is widely recognized that people in developed countries eat energy-rich food with high fat and carbohydrate contents which is reflected by a great number of people with overweight or obesity. There is a growing interest of reducing sugar content in food products, and in this way also to partly reduce the energy content of the food products.

There are low sugar acidified milk products in the market, and it can be seen a trend to reduce total sugar content of milk based snacks, like yoghurts and quarks. Typical adjectives describing low sugar acidified products, such as yogurts, in cases where the amount of added sugar is reduced or no sugar is added, are reduced sweetness, defects in aroma profile and excess acidity, for example. In cases where sweeteners are used, the products are characterised to have off-flavours and artificial taste.

WO 2018/115586 A1 discloses a process for the preparation of a low sugar acidified milk product. In the process, a milk raw material having a lactose content of about 0.6 weight-% to 2.5 weight-% is used as starting material. It is reported that it is possible to reduce the total sugar content of the acidified product by at least 30% without affecting the sweetness sensation.

Reducing lactose content in acidified milk products is one approach to reduce total sugar content of acidified milk products. Lactose reduction is possible for example with membrane filtration technology widely applied in dairy industry. The drawback of milk products where lactose is reduced with membrane filtration is in certain cases bland and empty taste, which cannot be fully compensated with added sugar, sweeteners, food flavours or a mixture of milk based minerals.

Therefore, there is still a need for providing low sugar acidified milk products which have an appealing, rich and fresh natural taste of yoghurt and have a yoghurt-like texture.

### BRIEF DESCRIPTION OF THE INVENTION

An object of the present invention is to provide a method for producing a low sugar acidified milk product with excellent taste and structure.

Another object of the invention is to provide a low sugar acidified milk product with excellent taste and structure.

The separation of milk components, that is fat, protein, lactose and milk minerals, with membrane filtrations using different membrane sizes has been widely described in the literature. For example, whole milk may be subjected to sequential steps of microfiltration, ultrafiltration, nanofiltration and reverse osmosis which provide a fat rich fraction, a protein rich fraction, a lactose rich fraction and a milk mineral rich fraction, respectively. For example, WO 03/094623 A1 discloses separation of milk protein, lactose and milk minerals into separated fractions using ultrafiltration, nanofiltration and reverse osmosis. In the present invention, the low sugar acidified milk product is produced from a milk base which comprises various fractions derived from milk including a protein fraction, a fat fraction and a mineral fraction, and optionally a lactose fraction produced by using appropriate membrane filtration techniques. Lactose is conveniently separated from an ultrafiltered milk protein concentrate using nanofiltration.

Citrate is a natural constitute of milk. Bovine milk typically contains about 0.1% to about 0.25% of citrate. It was found in the present invention that in the separation of lactose from an ultrafiltered milk protein concentrate by nanofiltration, citrate is concentrated together with lactose into a nanofiltration retentate. It was also found that magnesium is filtrated together with lactose into the retentate. When an acidified milk product is produced from the ultrafiltered milk protein concentrate without using the nanofiltration retentate rich in lactose, the acidified milk product exhibits a reduced citrate level compared with that originally present in milk.

It was unexpectedly found in the present invention that by adjusting the citrate level of the low sugar and low lactose acidified milk product to a natural level of milk it was possible to reduce the total sugar content of the acidified milk product up to 70% by weight compared with yoghurt having a lactose content of 3.9%, without negatively affecting the sensory properties, such as full and rich yoghurt flavour. In addition, by adjusting the citrate level to a natural level of milk the buffering capacity of the milk base is increased which is beneficial during the fermentation of the milk base. Fermentation of the milk base with increased buffering capacity provides an acidified milk product with natural yoghurt-like taste. Further, magnesium lost in the filtration steps of milk may be returned to the low sugar acidified milk product by adding citrate in the form of trimagnesium citrate. In a typical, non-lactose reduced yoghurt milk the lactose content before fermentation is 4.5-5.5%.

Composing a milk base in an appropriate manner and then subjecting the milk base to a conventional yoghurt manufacturing process including fermentation, a ready-to-consume low sugar yoghurt with natural, fresh taste and yoghurt-like structure is achieved. Likewise, quark products with rich and full taste may be produced with a conventional quark manufacturing process.

### BRIEF DESCRIPTION OF THE DRAWINGS

FIG. 1 shows a correlation between a citrate content and a lactose content of a yoghurt milk base;

FIG. 2 shows the changes of pH of yoghurts during 5 weeks' storage;

FIG. 3 shows the titratable acidity (° SH) of yoghurts during 5 weeks' storage;

FIG. 4 shows overall palatability of yoghurts in sensory scores;

FIG. 5a shows the titratable acidity (° SH) of the yoghurts;

FIG. 5b shows the pH of yoghurts.

### DETAILED DESCRIPTION OF THE INVENTION

The percentages of the various constituents in the present invention are given on weight basis.

The percentages of a citrate preparation are calculated as a pure citrate.

In an aspect, the invention provides a method for producing a low sugar acidified milk product, comprising the steps of:
providing a milk base having a protein content of about 2.5% to about 8%, a fat content of about 0% to about 10%, a lactose content of about 0.6% to about 2.5% and an ash content of about 0.6% to about 0.9%,
adding a citrate preparation to the milk base,
optionally homogenizing the milk base,
heat treating the milk base,
fermenting the milk base with a starter culture to provide a low sugar acidified milk product having a pH of about 4.4 to about 4.7.

The method of the invention produces a low sugar acidified milk product which is a ready-to-consume product with appealing taste.

In an embodiment, the term “milk” means bovine milk. Bovine milk has typically a lactose content of about 4.5%.

In an embodiment, the citrate preparation added to the milk base is a commercially available product. In another embodiment, the citrate preparation is citrate isolated from milk. The added citrate preparation is selected from a trimagnesium citrate, tripotassium citrate, tricalcium citrate, trisodium citrate, citrate isolated from milk and any mixture thereof. The citrate preparation added in said amount restores the citrate content of a milk base to a level originally present in bovine milk, i.e., to a range of about 0.1% to about 0.25%, calculated as a pure citrate.

The low sugar acidified milk product produced by the method of the invention comprises added citrate preparation in an amount of about 0.1% to about 0.18%, calculated as a pure citrate. In an embodiment, the low sugar acidified milk product produced by the method of the invention comprises about 0.12% of the added citrate preparation. In an embodiment, the low sugar acidified milk product produced by the method of the invention comprises added citrate preparation in an amount of about 0.1% to about 0.18%, specifically about 0.12%, calculated as a Perhonen123pure citrate, and at most about 2.5% of glucose, galactose and lactose in total.

In an embodiment of the method of the invention, the citrate preparation is added to the milk base, containing about 0.6% to about 2.5% of lactose, in an amount of about 0.1% to about 0.18% calculated as a pure citrate to adjust the citrate level to the natural level of milk. In another embodiment, the citrate preparation is added in an amount of about 0.12% calculated as a pure citrate.

In an embodiment, the method of the invention involves a lactose hydrolysis step by adding a lactase enzyme. Lactase may be added to the milk base prior to, after or during the addition of a citrate preparation. In an embodiment, lactase is added to the milk base containing about 0.6% to about 2.5% of lactose to hydrolyse at least a part of said lactose content to monosaccharides, i.e., glucose and galactose.

In an embodiment, the citrate preparation is added in an amount of about 0.1% to about 0.18%, calculated as a pure citrate, to the milk base comprising about 0.6% to about 2.5% of glucose, galactose and lactose in total to adjust the citrate level to the natural level of milk. In another embodiment, about 0.12%, calculated as a pure citrate, is added to the milk base comprising about 0.6% to about 2.5% of glucose, galactose and lactose in total.

In an embodiment, the citrate preparation is added to the milk base prior to the acidification.

In an embodiment, citrate preparation is added to the milk base prior to pasteurization.

The total sugar content of the low sugar acidified milk product produced by the method of the invention is in the range of about 0.6% to about 10%. Total sugar of the low sugar acidified milk product encompasses both sugar compounds originated from milk, i.e., lactose, glucose and galactose, and optionally external sugar-containing sweeteners. External sugar-containing sweeteners means non-dairy sugars, such as saccharose. In the present invention, the term “low sugar acidified milk product” means that the total amount of milk-derived sugars, i.e., lactose, glucose and galactose, of the product is about 0.6% to about 2.5%.

In an embodiment, the total sugar content of the low sugar acidified milk product produced by the method of the invention is in the range of about 0.9% to about 5.5%, wherein the content of milk-derived sugars is in the range of about 0.6% to about 2.5% based on the weight of the low sugar acidified milk product. In an embodiment, the total sugar content is in the range of about 0.9% to about 2.5%. In another embodiment, the total sugar content is in the range of about 3.0% to about 8.0%.

In an embodiment, in the low sugar acidified milk product produced by the method of the invention has a lactose content of at most 0.01%.

In an embodiment, the low sugar acidified milk product produced by the method of the invention comprises total citrate which means added citrate and milk-originating citrate in a concentration between about 0.1% and about 0.25% calculated as pure citrate.

In an embodiment, the total citrate concentration of the acidified milk product produced by the method of the invention is in the range of about 0.13% to about 0.17% calculated as pure citrate. In another embodiment, the total citrate concentration in the acidified milk product is in the range of about 0.13% to about 0.18% calculated as pure citrate. In a further embodiment, the total citrate concentration in the acidified milk product is in the range of about 0.15% to about 0.20% calculated as pure citrate. In a still further embodiment, the total citrate concentration of the acidified milk product is in the range of about 0.16% to about 0.17%.

In an embodiment, the low sugar acidified milk product produced by the method of the invention is yoghurt. In another embodiment, the low sugar acidified milk product produced by the method of the invention is quark. The invention is described in more detail below in respect of yoghurt, however without limiting the invention thereto.

In an embodiment, the milk base comprises a milk protein concentrate, cream, a milk mineral concentrate, and water. In an embodiment, a lactose concentrate, skim milk and/or saccharose is also included in the milk base.

In an embodiment of the present invention, the milk protein concentrate is produced by concentrating skim milk by ultrafiltration. The fat content of the skim milk is ≤0.2%. The protein content of the milk protein concentrate is in the range of about 11% to about 13%. The lactose content of the milk protein concentrate is in the range of about 3% to about 5%. In an embodiment, the fat content of the milk protein concentrate is ≤0.3%. The citrate content of the milk protein concentrate is in the range of about 0.14% to about 0.25%.

The resultant ultrafiltration permeate collected from skim milk ultrafiltration is further subjected to nanofiltration to concentrate lactose to a retentate. The resultant lactose concentrate, optionally included in the milk base, has a lactose content of about 16% to about 18%.

The nanofiltration provides a nanofiltration permeate which is subjected to a reverse osmosis filtration to concentrate milk minerals to a retentate. The milk mineral concentrate mainly contains monovalent minerals, such as sodium and potassium, but also minor amounts of calcium, magnesium and phosphorus. The content of ash, i.e., milk minerals, of the milk mineral concentrate is in the range of about 1.2% to about 1.6%. In an embodiment of the invention, a reverse osmosis retentate having an ash content of about 1.2% to about 1.6% is used as a milk mineral concentrate in the method.

The reverse osmosis filtration provides a permeate which is substantially free of milk components and is similar to water. The water constituent in the milk base may be the reverse osmosis permeate or tap water.

In another embodiment of the invention, the milk protein concentrate is composed of whey protein concentrate and casein concentrate. The whey protein concentrate is an ultrafiltration retentate of microfiltration permeate of skim milk. In the whey protein concentrate, whey proteins are in the native form. The casein concentrate may be produced from milk as a microfiltration retentate.

In an embodiment of the invention, the lactose content of the milk base is reduced with membrane filtration technology.

In an embodiment, the lactose content is reduced with membrane filtration technology and with enzymatic hydrolysis.

In an embodiment, the lactose content is reduced with membrane filtration technology and with enzymatical hydrolysis and as a result of acidifiers metabolic process.

Typically, in microbiological acidifying and fermentation of yoghurts and quarks, about 0.5% to about 1.5% of the lactose in the milk base is transformed into lactic acid in the fermentation process.

The cream used in the milk base may be obtained from whole milk by a separator. The cream may also be obtained by microfiltering whole milk to provide a cream fraction as microfiltration retentate. The fat content of the cream is in the range of about 38% to about 40%.

In an embodiment of the invention, cream, a milk protein concentrate, a milk mineral concentrate and a lactose concentrate are derived from a single unitary membrane filtration process carrying out sequential steps of microfiltration, ultrafiltration, nanofiltration and reverse osmosis. In another embodiment, cream, a milk protein concentrate, a milk mineral concentrate and a lactose concentrate are produced independently in separate processes.

The milk base comprises protein in an amount of about 2.5% to about 8%. In one embodiment, the amount of protein is about 3% to about 5%. In another embodiment, the amount of protein is about 2.5% to about 4.5%. In a further embodiment, the amount of protein is about 3.5% to about 4.0%. in a still further embodiment, the amount of protein is about 3.5% to about 4.5%.

The milk base comprises fat in an amount of about 0% to about 10%. In an embodiment, the milk base comprises about 2% to about 3% of fat.

The milk base comprises lactose in an amount of about 0.6% to about 2.5%. In an embodiment, the amount of lactose is about 1.4% to about 2.2%.

The total amount of glucose, galactose and lactose of the milk base is in the range of about 0.6% to about 2.5%.

The milk base comprises ash in an amount of about 0.6% to about 0.9%. In an embodiment, the amount of ash is about 0.8%.

In an embodiment, the milk base contains about 3.5% to about 3.7% of protein, about 2.2% of fat, about 1.4% to about 2.2% of lactose and about 0.8% of ash.

In an embodiment, the milk base contains 0% of lactic acid.

In an embodiment, the milk base contains about 0.02% to about 0.05% of sodium.

In an embodiment, the milk base contains about 0.09% to about 0.12% of calcium.

In an embodiment, the milk base contains about 0.12% to about 0.21% of potassium.

In an embodiment, the milk base contains about 0.006% to about 0.013% of magnesium.

In an embodiment, the milk base contains about 0.07% to about 0.11% of phosphorus.

In an embodiment, the milk base exhibits total solids of about 5% to about 17%. In another embodiment, the total solids content is about 8% to about 15%.

The milk base is standardized to desired protein, fat, lactose and ash contents. Water or membrane filtration permeates such as reverse osmosis permeate may be used and may be necessary to use in completing the standardization step.

In an embodiment, the homogenizing of the milk base is performed. Homogenizing is especially preferred when fat is present. In an embodiment, homogenization is carried out at 60° C. and at 50/150 bar, when needed. In an embodiment, the milk base standardized to desired protein, fat, lactose and ash contents is then homogenized in a conventional manner.

The milk base is heat-treated using methods known per se. Useful heat-treatment processes are, among others, pasteurisation, high-pasteurisation, thermisation, UHT treatment and ESL treatment. Examples of suitable heat-treatments include heating at 80-90° C. for 15 seconds to 10 minutes, UHT treatment at 120-150° C. for 1 to 6 seconds and ESL treatment at 135° C. for 0.5 seconds. The heat-treatment may also be performed in several steps. In one embodiment, the heat treatment is performed also as a post-heat-treatment, specifically as thermisation and/or as pasteurisation. In an embodiment, the milk base is pasteurized at 90° C. for 5 minutes when used in the production of yoghurt. In an embodiment, the milk base is pasteurized at 86° C. for 7 minutes when used in the production of quark.

After optional homogenization and after heat treatment, such as pasteurization, the milk base is subjected to fermentation. The fermentation is performed by microbiological souring by utilising biological starters specific to each product (e.g., bulk starter or direct to vat starter DVI/DVS). For instance, the Lactobacillus delbrueckii subsp. bulgaricus and Streptococcus thermophilus strains are conventionally used in yogurt production. In an embodiment, other bacterial species from genera Lactobacillus, and Bifidobacterium, e.g. Lactobacillus acidophilus, Bifidobacterium animalis and Bifidobacterium lactis may be included. The lactic acid bacteria strains used in the method of invention do not include those which involve in citrate metabolism reaction and produce citrate degradation products.

In an embodiment, the fermentation is carried out at about 30° C. to about 42° C.

In an embodiment, fermentation is carried out until pH of about 4.5 to about 4.7, preferably until pH of about 4.5 to about 4.6. In an embodiment, fermentation is carried out until pH of about 4.55.

In an embodiment, sugar, such as saccharose, is added to the milk base prior to fermentation to provide sweetness to a low sugar acidified milk product. In an embodiment, the amount of saccharose of the milk base is in the range of about 1.0% to about 5.0%. In another embodiment, the amount of saccharose is about 3.0% to about 4.6%.

After fermentation, the resultant low sugar acidified milk product is smoothened, cooled to about room temperature and packed to suitable containers.

In an embodiment, the method of the invention involves a lactose hydrolysis step by adding a lactase enzyme to the milk base to decompose lactose to monosaccharides, i.e., glucose and galactose. In an embodiment, lactase enzyme is added prior to fermentation. In another embodiment, lactase enzyme is appropriately added in the step of fermentation.

The addition of citrate to the milk base makes it possible to reduce the total sugar content of an acidified milk product without impairing the taste of the product. In the context of the present invention, the term “sugar” encompasses saccharose (also called sucrose or table sugar), lactose, glucose, galactose and fructose.

In an embodiment, the low sugar acidified milk product produced by the method of the invention is non-flavoured. Here, the term “non-flavoured” means that the low sugar acidified milk product does not contain an external sugar-containing sweetener or a non-caloric sweetener. In the non-flavoured low sugar acidified milk product, the total sugar content is provided only by sugars originating from milk, i.e., lactose, glucose and galactose, which are present in various constituents or membrane filtration fractions used in the manufacture of the low sugar acidified milk product. Glucose and galactose are appropriately provided by hydrolysis of lactose.

In another embodiment, the non-flavoured low sugar acidified milk product produced by the method of the invention is flavoured with an external non-dairy sugar-containing sweetener. The external sugar-containing sweetener may be any sugar-containing substance, such as saccharose and fructose provided by jam, fruits, fruit juice extracts, berries, syrup, honey, without limiting thereto. The external sugar-containing sweetener may be added during the manufacture of the acidified milk product or after fermentation to the final product.

Thus, the total sugar content of a low sugar acidified milk product of the invention is composed of sugar compounds, including lactose, glucose and galactose, which originate from milk and are present in various fractions used in the manufacture of the acidified milk product, and optionally an external sugar-containing sweetener which is added during the manufacture of the product or to a final product.

The total sugar content of a low sugar acidified milk product produced by the method of the invention may vary in the range of about 0.6% up to about 10%. In an embodiment, the total sugar content of the non-caloric sweetener flavoured low sugar acidified milk product produced by the method of the invention is in the range of about 0.6% about 2.5%. The total sugar content of the non-flavoured low sugar acidified milk product produced by the method of the invention is typically in the range of about 0.6% about 2.5%. The total sugar content of the flavoured low sugar acidified milk product is typically in the range of about 2% up to about 10%. In an embodiment, the total sugar content of the flavoured low sugar acidified milk product is about 8%.

The energy content of the low sugar acidified milk product produced by the method of the invention is in the range of about 80 kJ/100 g yoghurt to about 550 kJ/100 g yoghurt.

In an embodiment, the low sugar acidified milk product produced by the method of the invention contains non-caloric sweetener(s), such as aspartame.

In an embodiment, the low sugar acidified milk product produced by the method of the invention is lactose free. In the context of the present invention, the term “lactose free” means that the lactose content of the low sugar acidified milk product is at most 0.01%.

Additional constituents may be added to the low sugar acidified milk product, such as aroma compounds (vanilla, lemon), vitamins, etc.

The total solids content of the low sugar acidified milk product produced by the method of the invention is in the range of about 5% to about 17%. In an embodiment, total solids content is about 8% to about 15%.

The titratable acidity of the low sugar acidified milk product is in the range of about 27° SH to about 40° SH.

The low sugar acidified milk product of the present invention produced by the method of the invention was found to have more natural and rich yoghurt flavor in sensory analyses and was more pleasant than the reference yoghurt without citrate addition.

In another aspect, the invention provides a low sugar acidified milk product comprising added citrate preparation in an amount of about 0.1% to about 0.18%, calculated as a pure citrate.

In a further aspect, the invention provides a low sugar acidified milk product, wherein the total citrate concentration of the product is in the range of about 0.1% to about 0.25% calculated as pure citrate.

In an aspect, the invention provides a low sugar acidified milk product obtainable by the method of the invention.

The total amount of citrate of the low sugar acidified milk products of the invention is about 0.1% to about 0.25%, calculated as pure citrate, specifically about 0.15% to about 0.20%, more specifically about 0.13% to about 0.18%, even more specifically about 0.16% to about 0.17%.

The protein content of the low sugar acidified milk products is about 2.5 to about 8%, specifically about 3% to about 5%, more specifically about 3.5% to about 4.5%, even more specifically about 3.5% to about 4.0%.

The fat content of the low sugar acidified milk products is about 0% to about 10%, specifically about 2% to about 3%.

The ash content of the low sugar acidified milk products is about 0.6% to about 0.9%, specifically about 0.8%.

The total amount of glucose, galactose and lactose of the low sugar acidified milk products of the invention is in the range of about 0.6% to about 2.5%.

The total sugar content of the low sugar acidified milk products of the invention is in the range of about 0.6% to about 10%. In an embodiment, the total sugar content of the low sugar acidified milk product is in the range of about 0.9% to about 5.5%. In an embodiment, the total sugar content is in the range of about 0.9% to about 2.5%. In another embodiment, the total sugar content is in the range of about 3.0% to about 6.0%. In a further embodiment, the total sugar content is about 8.0%.

In an embodiment, a low sugar acidified milk products of the invention has a total sugar content of 0.6% to 8%, 0.6% to 2.5% of glucose, galactose and lactose in total, and a total citrate of 0.1% to 0.25% (comprising added citrate preparation), specifically about 0.1% to about 0.18%, specifically about 0.12%, calculated as a pure citrate.

The total solids content of the low sugar acidified milk products of the invention is in the range of about 5% to about 17%. In an embodiment, the total solids content is about 8% to about 15%.

The energy content of the low sugar acidified milk products is in the range of about 80 kJ/100 g to about 550 kJ/100 g.

The titratable acidity of the low sugar acidified milk products of the invention is in the range of about 27° SH to about 40° SH.

In an embodiment, the low sugar acidified milk product is yoghurt. In another embodiment, the low sugar acidified milk product is quark.

The following examples are presented for further illustration of the invention without limiting the invention thereto.

Sensory properties of the yoghurts were tested. Total number of participants (N) in the test of Example 2 was 20. In the other Examples, the total number of the participants was 5-6.

The titratable acidity (° SH) was measured according to a standard ISO/TS 11869/IDF/RM 150:2012, where samples were determined by measuring the amount of 0.1N NaOH necessary to adjust to pH 8.3. ° SH was calculated by equation a*40:b, where a=ml of 0.1 N NaOH and b=weight (g) of the sample.

Citrate was measured according to a method IDE 34C:1992 and performed with enzymatic Boehringer Mannheim UV-test Cat. no. 10 139 076 035.

### EXAMPLE 1

Skim milk having a fat content of 0.2% was subjected to ultrafiltration to concentrate milk protein to a retentate (“milk protein concentrate”).

The resultant ultrafiltration permeate was subjected to nanofiltration to concentrate lactose from the permeate to a nanofiltration retentate (“lactose concentrate”).

The resultant nanofiltration permeate was subjected to reverse osmosis to concentrate milk minerals from the permeate to a reverse osmosis retentate “milk mineral concentrate”).

The composition of the milk protein concentrate, lactose concentrate and milk mineral concentrate obtained above, and of skim milk and cream used in the production of the yoghurts exemplified below are shown in Table 1.

TABLE 1

| | | | Dry | Lac- | | Magne- | |
|---|---|---|---|---|---|---|---|
| | Protein | Fat | matter | tose | Ash | sium | Citrate |
| Milk fraction | % | % | % | % | % | (mg/kg) | % |
| Milk protein | 12.40 | 0.22 | 18.03 | 4.10 | 1.40 | 220 | 0.15 |
| concentrate | | | | | | | |
| Lactose | 0.35 | 0.01 | 19.76 | 17.50 | 1.10 | 260 | 0.82 |
| concentrate | | | | | | | |
| Milk mineral | 0 | 0 | 2.9 | 0.5 | 1.35 | 15 | 0.04 |
| concentrate | | | | | | | |
| Skim milk | 3.6 | 0.07 | 9 | 4.63 | 0.77 | 120 | 0.18 |
| Cream | 1.82 | 39 | 43.3 | 2.6 | 0.4 | 73 | 0.11 |

The milk protein concentrate and the milk mineral concentrate identified in Table 1 are used in the production of yoghurts and quark in Examples 2-4, 6 and in Example 5, respectively.

### REFERENCE EXAMPLE 1

### Low Sugar Yoghurts Without Citrate Addition

The milk protein concentrate, cream, milk mineral concentrate identified in Table 1, water and saccharose were combined to provide a yoghurt milk, i.e., milk base, having 3.7% of protein, 2.2% of fat, 0.8% of ash, 2.2% of lactose and 4.6% of saccharose. The total amount of sugars in the yoghurt milk was 6.8%.

The yoghurt milk was homogenized at 60° C. and at 50/150 bar and then pasteurized at 90° C. for 5 minutes. After pasteurization, the yoghurt milk was cooled to 42° C. A yogurt starter containing Lactobacillus delbrueckii subsp. bulgaricus and Streptococcus thermophilus strains (0.01%) and a lactase enzyme (0.01%) was added to the cooled yoghurt milk. Fermentation was carried out at 42° C. until pH of 4.5 was reached.

Yoghurt mass was smoothened with a rotor stator smoothing pump, cooled to 20° C. and packed to provide yoghurt (“yoghurt 1”).

“yoghurt 2” was produced in a similar manner as “yoghurt 1” except that the lactose concentrate was added in addition to other ingredients. A yoghurt milk for “yoghurt 2” contained 3.7% of protein, 2.2% of fat, 0.8% of ash, 3.2% of lactose and 3.6% of saccharose. The total amount of sugars in the yoghurt milk was 6.8%.

“yoghurt 3” was produced from a yoghurt milk which contained the milk protein concentrate, cream, the lactose concentrate, the milk mineral concentrate, water and saccharose. The yoghurt milk contained 3.7% of protein, 2.2% of fat, 0.8% of ash, 4.2% of lactose and 2.6% of saccharose. The total amount of sugars in the yoghurt milk was 6.8%. The yoghurt milk was processed to yoghurt in a similar manner as described for “yoghurt 1”.

“yoghurt 4” was produced form a yoghurt milk which contained the milk protein concentrate, cream, the lactose concentrate, the milk mineral concentrate, water and saccharose. The yoghurt milk contained 3.7% of protein, 2.2% of fat, 0.8% of ash, 5.5% of lactose and 1.1% of saccharose. The total amount of sugars in the yoghurt milk was 6.8%. The yoghurt milk was processed to yoghurt in a similar manner as described for “yoghurt 1”.

The composition of the above yoghurts is described in Table 2 below.

TABLE 2

| | Protein | Fat | Ash | Total sugar | Lactic acid | Dry matter |
|---|---|---|---|---|---|---|
| Yoghurt | % | % | % | % | % | % |
| 1 | 3.93 | 2.27 | 0.78 | 5.88 | 0.82 | 13.7 |
| 2 | 3.94 | 2.24 | 0.79 | 5.95 | 0.85 | 13.8 |
| 3 | 3.96 | 2.25 | 0.79 | 6.07 | 0.83 | 13.9 |
| 4 | 3.98 | 2.25 | 0.8 | 5.76 | 0.84 | 13.6 |

The sensory analysis of the yoghurts revealed that “yoghurt 1” and “yoghurt 2” with low lactose contents exhibited sweet, watery and bland/empty taste. The “yoghurt 3” and “yoghurt 4” with conventional initial lactose contents exhibited less sweet and more acidic taste.

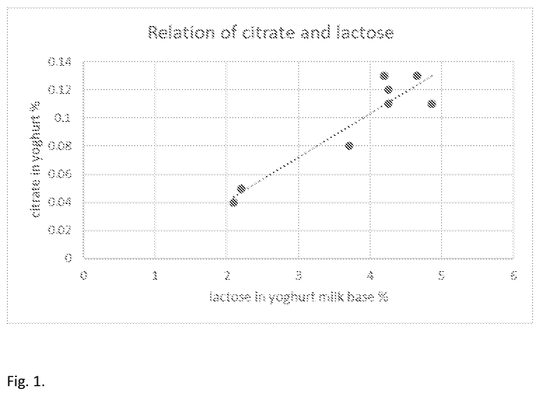

FIG. 1 shows a correlation between a citrate content of a yoghurt and a lactose content of yoghurt milk base from samples composed in a similar manner as in Reference example 1. It was observed in the data of FIG. 1 that when lactose content of yoghurt milk base is reduced by membrane filtration, the citrate content in yoghurt reduces. It is assumed that watery and bland taste of yoghurt 1 and yoghurt 2 were at least partly due to a reduced amount of citrate in the yoghurts.

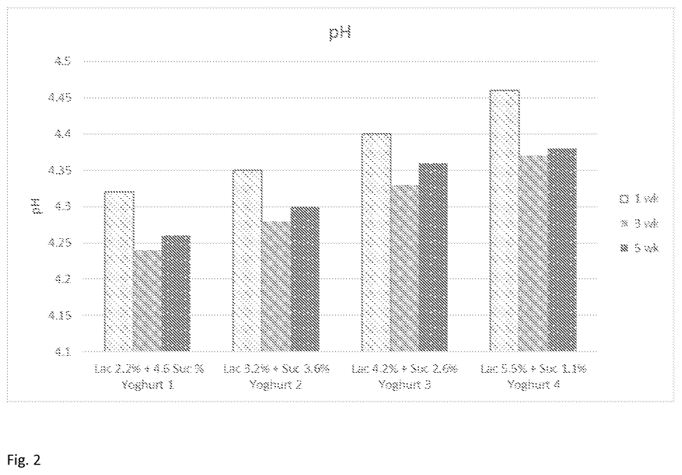

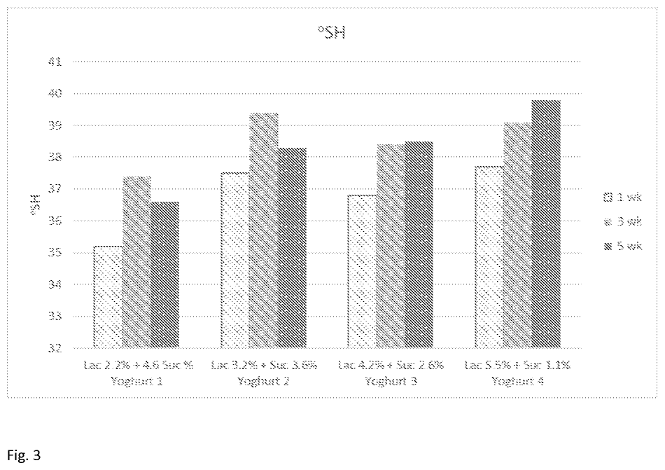

The pH and titratable acidity (° SH) of the yoghurts were analysed. The results are shown in FIGS. 2 and 3, respectively. FIG. 2 shows the changes of pH of the yoghurts during 5 weeks' storage. FIG. 2 also shows that the pH of the yoghurts with low lactose contents (2.2% and 3.2%) is lower than that of the yoghurts with typical lactose contents (4.2% and 5.5%), although the yoghurts with low lactose contents contained less acid compounds (seen as a low ° SH value) generated in the fermentation.

The content of acid compounds is reflected by the titratable acidity shown in FIG. 3. In FIG. 2 and FIG. 3 Lac refers to lactose and Suc refers to sucrose.

The fact that a smaller amount of acidic compound (seen as low titratable acidity, ° SH of 2.2% and 3.2% lactose containing yoghurts) resulted in bigger drop in pH (lower pH value) compared to the 4.2% and 5.5% lactose-containing yoghurts, lead to hypothesis that the buffering capacity of a milk base became worse when the amount of lactose fraction in the milk base was reduced or omitted (yoghurt 1), and also lead to the present invention to add citrate preparation to improve the buffering capacity and to tackle the taste defect in the acidified product.

### EXAMPLE 2

### Low Sugar Yoghurts

The milk protein concentrate, cream, the milk mineral concentrate and water were combined to provide a yoghurt milk. 0.12% of pure citrate based on the weight of the yoghurt milk was added as trimagnesium citrate anhydrous (0.031%) and tripotassium citrate monohydrate (0.125%) to the yoghurt milk to achieve a natural citrate level of milk.

The yoghurt milk had a following composition: 3.7% protein, 2.2% fat, 0.8% ash, 1.5% lactose, 8.2% dry matter, citrate 0.17%, lactic acid 0%, Na 360 mg/kg, Ca 1050 mg/kg, K 2020 mg/kg, Mg 120 mg/kg and P 810 mg/kg.

The yoghurt milk containing citrate was homogenized at 60° C. and at 50/150 bar and then pasteurized at 90° C. for 5 minutes. After pasteurization, the yoghurt milk was cooled to 42° C. A lactase enzyme and a yogurt starter containing Lactobacillus delbrueckii subsp. bulgaricus and Streptococcus thermophilus strains (0.01%) were added to the cooled yoghurt milk. Fermentation was carried out at 42° C. until pH of 4.5 was reached.

Yoghurt mass was smoothened with a rotor stator smoothing pump, cooled to 20° C. and packed to provide yoghurt of the invention (“Ex. 2”).

A reference yogurt (“Ref. Ex. 2”) was produced in a similar manner from a yoghurt milk containing the milk protein concentrate, cream, the milk mineral concentrate and water except that no trimagnesium citrate and tripotassium citrate were added. The reference yoghurt milk had a following composition: 3.7% protein, 2.2% fat, 0.8% ash, 1.5% lactose, 8.2% dry matter, citrate 0.06%, lactic acid 0%, Na 360 mg/kg, Ca 1050 mg/kg, K 1570 mg/kg, Mg 70 mg/kg and P 810 mg/kg.

The composition of the yoghurts is given in Table 3 below.

TABLE 3

| | Protein | Fat | Total | Ash | Dry | Citrate | Lactic |
|---|---|---|---|---|---|---|---|
| Yoghurt | % | % | sugar % | % | matter % | % | acid % |
| Ex. 2 | 4.0 | 2.3 | 0.8 | 0.8 | 8.5 | 0.17 | 0.63 |
| Ref. Ex. 2 | 4.2 | 2.3 | 1.1 | 0.7 | 9.0 | 0.08 | 0.61 |

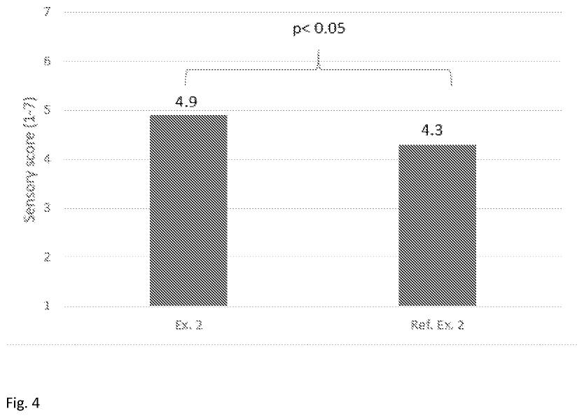

The sensory properties of the yoghurts given in sensory scores 1-7 (1=not appealing; 7=very appealing) are shown in FIG. 4. The results show that the yoghurt of the invention (Ex. 2) with a citrate addition was found more appealing than the reference yoghurt without citrate addition (Ref. Ex. 2). The difference in sensory scores is statistically significant (P<0.05).

### EXAMPLE 3

### Low Sugar Yoghurts

The milk protein concentrate, cream, the milk mineral concentrate, water and saccharose were combined to provide a yoghurt milk. 0.126% of pure citrate based on the weight of the yoghurt milk was added as trimagnesium citrate anhydrous (0.032%) and tripotassium citrate monohydrate (0.156%) to the yoghurt milk to achieve a natural citrate level of milk.

The yoghurt milk had a following composition: 3.7% protein, 2.2% fat, 0.8% ash, 2.1% lactose, 4.6% of saccharose, 12.4% dry matter, citrate 0.13%, lactic acid 0%, Na 320 mg/kg, Ca 1100 mg/kg, K 1900 mg/kg, Mg 130 mg/kg and P 780 mg/kg. The total amount of sugars (lactose and saccharose) in the yoghurt milk was 6.7%.

The yoghurt milk containing citrates was homogenized at 60° C. and at 50/150 bar and then pasteurized at 90° C. for 5 minutes. After pasteurization, the yoghurt milk was cooled to 42° C. A lactase enzyme and a yogurt starter containing Lactobacillus delbrueckii subsp. bulgaricus and Streptococcus thermophilus strains (0.01%) was added to the cooled yoghurt milk. Fermentation was carried out at 42° C. until pH of 4.5 was reached.

Yoghurt mass was smoothened with a rotor stator smoothing pump, cooled to 20° C. and packed to provide yoghurt of the invention. The sugar content of the yoghurt was 5.2%.

A reference yogurt (Ref. Ex. 3) was produced in a similar manner from a yoghurt milk containing the milk protein concentrate, cream, the milk mineral concentrate and water except that no trimagnesium citrate and tripotassium citrate were added. The reference yoghurt milk had a following composition: 3.7% protein, 2.2% fat, 0.8% ash, 2.1% lactose, 4.6% of saccharose, 12.4% dry matter, citrate 0.05%, lactic acid 0%, Na 430 mg/kg, Ca 1100 mg/kg, K 1700 mg/kg, Mg 86 mg/kg and P 780 mg/kg.

The composition of the yoghurts is given in Table 4 below.

TABLE 4

| | Protein | Fat | Ash | Total | Lactic | Dry | Citrate |
|---|---|---|---|---|---|---|---|
| Yoghurt | % | % | % | sugar % | acid % | matter % | % |
| Ref. Ex. 3 | 3.8 | 2.3 | 0.8 | 5.2 | 0.82 | 12.8 | 0.05 |
| Ex. 3 | 3.8 | 2.3 | 0.8 | 5.2 | 0.84 | 12.8 | 0.13 |

The yoghurt of the invention (Ex. 3) exhibited a fresh, yoghurt-like taste. Instead, the reference yoghurt exhibited watery and bland taste.

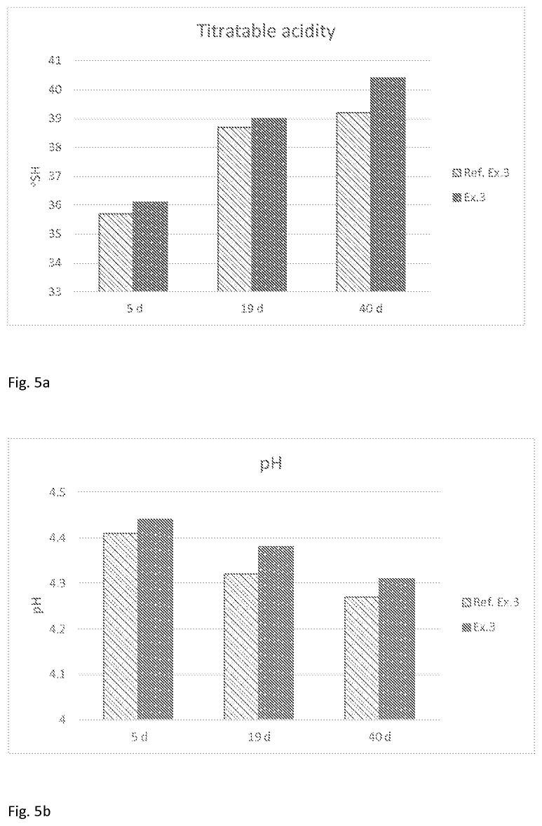

The titratable acidity (° SH) and pH of the yoghurts were analysed and are shown in FIGS. 5a and 5b, respectively. The Figures show that the addition of citrate increased the pH of the yoghurt although the titratable acidity increased indicating that the citrate addition increased the buffering capacity in the yoghurt. In addition, the citrate addition resulted in yoghurt with more viscosity as compared to the yoghurt without the citrate addition.

### EXAMPLE 4

### Low Sugar Yoghurts

The milk protein concentrate, cream, the milk mineral concentrate, water and saccharose were combined to provide a yoghurt milk. 0.12% of pure citrate based on the weight of the yoghurt milk was added as trimagnesium citrate anhydrous (0.031%) and tripotassium citrate monohydrate (0.125%) to the yoghurt milk to achieve a natural citrate level of milk.

The yoghurt milk had a following composition: 3.7% protein, 2.2% fat, 0.8% ash, 1.4% lactose, 3.1% of saccharose, 11.1% dry matter, citrate 0.17%, lactic acid 0%, Na 370 mg/kg, Ca 1000 mg/kg, K 1800 mg/kg, Mg 120 mg/kg and P 820 mg/kg. The total amount of sugars (lactose and saccharose) in the yoghurt milk was 4.5%.

The yoghurt milk containing citrates was homogenized at 60° C. and at 50/150 bar and then pasteurized at 90° C. for 5 minutes. After pasteurization, the yoghurt milk was cooled to 42° C. A yogurt starter containing Lactobacillus delbrueckii subsp. bulgaricus and Streptococcus thermophilus strains (0.01%) and a lactase enzyme were added to the cooled yoghurt milk. Fermentation was carried out at 42° C. until pH of 4.5 was reached.

Yoghurt mass was smoothened with a rotor stator smoothing pump, cooled to 20° C. and packed to provide yoghurt of the invention (Ex. 4). The total sugar content of the yoghurt was 3.7%.

A reference yogurt (Ref. Ex. 4) was produced in a similar manner from a yoghurt milk containing the milk protein concentrate, cream, the milk mineral concentrate and water except that no trimagnesium citrate and tripotassium citrate were added. The reference yoghurt milk had a following composition: 3.7% protein, 2.2% fat, 0.8% ash, 1.4% lactose, 3.1% of saccharose, 11.1% dry matter, citrate 0.06%, lactic acid 0%, Na 380 mg/kg, Ca 1000 mg/kg, K 1500 mg/kg, Mg 73 mg/kg and P 840 mg/kg.

The composition of the yoghurts is given in Table 5 below.

TABLE 5

| | Protein | Fat | Ash | Total | Lactic | Dry | Citrate |
|---|---|---|---|---|---|---|---|
| Yoghurt | % | % | % | sugar % | acid % | matter % | % |
| Ref. Ex. 4 | 3.8 | 2.2 | 0.7 | 3.7 | 0.86 | 11.3 | 0.04 |
| Ex. 4 | 3.7 | 2.2 | 0.8 | 3.8 | 0.83 | 11.2 | 0.16 |

The yoghurt of the invention was perceived to have more appealing taste than the reference yoghurt. The flavour of the yoghurt of the invention was more yoghurt-like, more acidic and tastier than the reference yoghurt. Also, the texture of the yoghurt of the invention was thicker and more yoghurt-like than the reference yoghurt.

### EXAMPLE 5

### Low Sugar Quarks

The milk protein concentrate, the milk mineral concentrate and water were combined to provide a quark milk. 0.12% of pure citrate, based on the weight of the quark milk was added as trimagnesium citrate anhydrous (0.031%) and tripotassium citrate monohydrate (0.125%) to the quark milk to achieve a natural citrate level of milk.

The quark milk had a following composition: 3.5% protein, 0.2% fat, 0.7% ash, 1.5% lactose, 5.9% dry matter, citrate 0.17%, lactic acid 0%, Na 370 mg/kg, Ca 1000 mg/kg, K 1800 mg/kg, Mg 120 mg/kg and P 820 mg/kg.

The quark milk containing citrates was pasteurized at 86° C. for 7 minutes followed by cooling to 42° C. A yogurt starter containing Lactobacillus delbrueckii subsp. bulgaricus and Streptococcus thermophilus strains (0.01%), a lactase enzyme and chymosin (0.00035%) were added to the cooled quark milk. Fermentation was carried out until pH of 4.5 was reached.

Quark mass was smoothened with a rotor stator smoothing pump, thermized at 63° C. for 2 minutes and concentrated by ultrafiltration at 50° C. until a total solids content of 11% was reached. Quark mass was cooled to 20° C. and packed to provide unflavoured quark of the invention (Ex. 5).

A reference unflavoured quark (Ref. Ex. 5) was produced in a similar manner from a quark milk containing the milk protein concentrate, cream, the milk mineral concentrate and water except that no trimagnesium citrate and tripotassium citrate were added. The reference quark milk had a following composition: 3.5% protein, 0.2% fat, 0.7% ash, 1.5% lactose, 5.9% dry matter, citrate 0.05%, lactic acid 0%, Na 380 mg/kg, Ca 1000 mg/kg, K 1500 mg/kg, Mg 73 mg/kg and P 840 mg/kg.

The composition of the unflavoured quarks is given in Table 6 below.

TABLE 6

| | | | | | | Dry | |
|---|---|---|---|---|---|---|---|
| | Protein | Fat | Ash | Total | Lactic | matter | Citrate |
| Quark | % | % | % | sugar % | acid % | % | % |
| Ref. Ex. 5 | 10.5 | 0.14 | 0.7 | 1.1 | 0.68 | 13.1 | 0.08 |
| Ex. 5 | 10.5 | 0.14 | 0.7 | 1.1 | 0.68 | 13.1 | 0.17 |

10% of a berry preparation containing 46% of saccharose was added the unflavoured quark of the invention to provide a flavoured quark of the invention. The total sugar content of the flavoured quark was 5.4%. The flavoured quark contained about 40% less sugar than a conventional quark product in the market. The flavoured quark exhibited rich and full taste.

### EXAMPLE 6

### Low Sugar Yoghurts

Skim milk, the milk protein concentrate, cream, the milk mineral concentrate, water and saccharose were combined to provide a yoghurt milk

0.07% of pure citrate based on the weight of the yoghurt milk was added as trimagnesium citrate anhydrous (0.019%) and tripotassium citrate monohydrate (0.09%) to the yoghurt milk to achieve a natural citrate level of milk.

The yoghurt milk had a following composition: 3.7% protein, 2.2% fat, 0.7% ash, 2.5% lactose, 5.0% of saccharose, 14.1% dry matter, citrate 0.17%, lactic acid 0%, Na 370 mg/kg, Ca 1100 mg/kg, K 1700 mg/kg, Mg 120 mg/kg and P 920 mg/kg. The total amount of sugars (lactose and saccharose) in the yoghurt milk was 7.5%.

The yoghurt milk containing citrates was homogenized at 60° C. and at 50/150 bar and then pasteurized at 90° C. for 5 minutes. After pasteurization, the yoghurt milk was cooled to 42° C. A lactase enzyme and a yogurt starter containing Lactobacillus delbrueckii subsp. bulgaricus and Streptococcus thermophilus strains (0.01%) were added to the cooled yoghurt milk. Fermentation was carried out at 42° C. until pH of 4.5 was reached.

Yoghurt mass was smoothened with a rotor stator smoothing pump, cooled to 20° C. and packed to provide yoghurt of the invention (“Ex. 6”). The total sugar content of the yoghurt was 6.9%.

A reference yogurt (“Ref. Ex. 6”) was produced in a similar manner from a yoghurt milk containing skim milk, the milk protein concentrate, cream, the milk mineral concentrate, water and saccharose except that no trimagnesium citrate and tripotassium citrate were added.

The reference yoghurt milk had a following composition: 3.7% protein, 2.2% fat, 0.8% ash, 2.5% lactose, 5.0% of saccharose, 14.1% dry matter, citrate 0.10%, lactic acid 0%, Na 370 mg/kg, Ca 1100 mg/kg, K 1400 mg/kg, Mg 88 mg/kg and P 910 mg/kg.

The composition of the yoghurts is given in Table 7 below.

TABLE 7

| | Protein | Fat | Ash | Total | Lactic | Dry | Citrate |
|---|---|---|---|---|---|---|---|
| Yoghurt | % | % | % | sugar % | acid % | matter % | % |
| Ref. Ex. 6 | 3.7 | 2.2 | 0.7 | 6.7 | 0.89 | 14.2 | 0.07 |
| Ex. 6 | 3.8 | 2.2 | 0.76 | 6.9 | 0.91 | 14.5 | 0.15 |

The yoghurt of the invention was perceived to have more appealing taste than the reference yoghurt.

It will be obvious to a person skilled in the art that, as the technology advances, the inventive concept can be implemented in various ways. The invention and its embodiments are not limited to the examples described above but may vary within the scope of the claims.

1.-43. (canceled)

44. A method for producing a low sugar acidified milk product, comprising the steps of:
providing a milk base having a protein content of about 2.5% to about 8%, a fat content of about 0% to about 10%, a lactose content of about 0.6% to about 2.5% and an ash content of about 0.6% to about 0.9%,
adding a citrate preparation to the milk base,
optionally homogenizing the milk base,
heat treating the milk base,
fermenting the milk base with a starter culture to provide a low sugar acidified milk product having a pH of about 4.4 to about 4.7.

45. The method of claim 44, wherein the milk base comprises about 3% to about 5% of protein.

46. The method of claim 44, wherein the milk base comprises a milk protein concentrate and a milk mineral concentrate.

47. The method of claim 46, wherein the milk protein concentrate is an ultrafiltration retentate of skim milk and contains ≤0.2% of fat, about 11% to about 13% of protein and about 3% to about 5% of lactose.

48. The method of claim 46, wherein the milk mineral concentrate is a reverse osmosis retentate containing about 1.2% to about 1.6% of ash.

49. The method of claim 44, wherein about 1.0% to about 5.0% of saccharose is added to the milk base.

50. The method of claim 44, wherein the total solids content of the milk base is in the range of about 5% to about 17%.

51. The method of claim 44, wherein the milk base contains at least one the following:
sodium content of about 0.02%% to about 0.05%,
calcium content of about 0.09% to about 0.12%,
potassium content of about 0.12% to about 0.21%,
magnesium content about 0.006% to about 0.013%,
phosphorus content of about 0.07% to about 0.11%.

52. The method of claim 44, wherein the citrate preparation is added to the milk base in amount of about 0.1% to about 0.18% calculated as pure citrate.

53. The method of claim 44, wherein the citrate preparation is selected from a trimagnesium citrate, tripotassium citrate, tricalcium citrate, trisodium citrate, citrate isolated from milk and any mixture thereof.

54. The method of claim 44, wherein the citrate preparation is added prior to the fermentation or prior to pasteurization.

55. The method of claim 44, wherein the starter culture excludes those which involve in citrate metabolism reaction.

56. The method of claim 44, wherein the starter culture is selected from Lactobacillus delbrueckii subsp. bulgaricus and Streptococcus thermophilus strains.

57. The method of claim 56, wherein bacterial species from genera Lactobacillus, and Bifidobacterium, e.g. Lactobacillus acidophilus, Bifidobacterium animalis and Bifidobacterium lactis are included.

58. The method of claim 44, wherein the fermentation is carried out at about 30° C. to about 42° C.

59. The method of claim 44, wherein the heat treatment is selected from pasteurisation, high pasteurisation, thermisation, UHT treatment and ESL treatment.

60. The method of claim 44, comprising a step of adding a lactase enzyme prior to or during the fermentation.

61. The method of claim 60, wherein the lactose content of the low sugar acidified milk product is at most 0.01%.

62. The method of claim 44, wherein the total sugar content of the low sugar acidified milk product is in the range of about 0.6% to about 10%.

63. The method of claim 44, wherein the total amount of glucose, galactose and lactose of the low sugar acidified milk product of the invention is in the range of about 0.6% to about 2.5%.

64. The method of claim 44, wherein the total citrate concentration of the low sugar acidified milk product is in the range of about 0.1% to about 0.25% calculated as pure citrate.

65. The method of claim 44, wherein the low sugar acidified milk product is yoghurt or quark.

66. The method of claim 44, wherein at least one of a non-caloric sweetener and a sugar-containing sweetener is added to the low sugar acidified milk product.

67. A low sugar acidified milk product, wherein the total citrate concentration of the product in the range of about 0.1% to about 0.25% calculated as pure citrate, and wherein the protein content of the product is about 2.5 to about 8%, and wherein the product has about 0.6% to about 2.5% of glucose, galactose and lactose in total.

68. The low sugar acidified milk product of claim 67, wherein the ash content of the product is about 0.6% to about 0.9%.

69. The low sugar acidified milk product of claim 67, wherein the total sugar content of the product is in the range of about 0.6% to about 10%.

70. The low sugar acidified milk product of claim 67, wherein the lactose content of the product is at most 0.01%.

71. The low sugar acidified milk product of claim 67, wherein the total solids of the low sugar acidified milk product is in the range of about 5% to about 17%.

72. The low sugar acidified milk product of claim 67, wherein the titratable acidity of the low sugar acidified milk product is about 27° SH to about 40° SH.

73. The low sugar acidified milk product of claim 67, wherein the low sugar acidified milk product contains at least one the following:
sodium content of about 0.02%% to about 0.05%,
calcium content of about 0.09% to about 0.12%,
potassium content of about 0.12% to about 0.21%,
magnesium content about 0.006% to about 0.013%,
phosphorus content of about 0.07% to about 0.11%.
